(19) United States
(12) Patent Application Publication
(10) Pub. No.: US 2006/0199005 A1
(43) Pub. Date: Sep. 7, 2006

(54) Electronic part taping packaging cover tape

(75) Inventors: Kazuhito Fuji, Tokyo-To (JP); Shinnichi Katou, Tokyo-To (JP)

Correspondence Address: OLIFF & BERRIDGE, PLC, P.O. BOX 19928, ALEXANDRIA, VA, 22320, US

(73) Assignee: Dai Nippon Painting Co., Ltd., Tokyo-to (JP)

(21) Appl. No.: 10/553,724

(22) PCT Filed: Apr. 26, 2004
(86) PCT No.: PCT/JP04/05981

§ 371 Date: Oct. 19, 2005

(30) Foreign Application Priority Data
Apr. 24, 2003 (JP) 2003-119929

(51) Int. Cl. B32B 27/32

(52) U.S. Cl. 428/347; 428/523; 428/354

(57) ABSTRACT

The present invention relates to a cover tape for tape packaging electronic components that heat-seals a carrier tape accommodating therein electronic components. A cover tape for tape packaging electronic components according to the present invention includes a substrate film layer, a soft material layer, and a thermal adhesive layer. The soft material layer is formed of metallocene linear low-density polyethylene having a specific gravity in a range of from 0.888 to 0.907.

### FIELD OF THE INVENTION

The present invention relates to a cover tape for tape-packaging electronic components. More particularly, it pertains to a cover tape for heat-sealing a carrier tape having continuous recesses for accommodating therein electronic components.

### BACKGROUND OF THE INVENTION

1. Background Art

Recently, chip-type electronic components such as IC chips and capacitors are tape-packaged in a carrier tape, and are supplied to an electronic circuit board to be surface-mounted thereon. The carrier tape has continuous recesses formed by embossing, for storing therein electronic components. After electronic components are contained in the respective recesses, the recesses are heat-sealed with a cover tape to form a tape package.

In order to mount the electronic component on an electronic circuit board, the cover tape is peeled from the tape package, and the electronic component is automatically taken out therefrom to be surface-mounted on the electronic circuit board. Thus, the cover tape must be easily peeled from the carrier tape.

When a peeling force (also referred to as “peeling strength”, “heat-seal strength”, or “peel-off strength”) of the cover tape is too low, the cover tape may be detached from the carrier tape so that the electronic components stored therein fall out of the tape package, when the tape package is moved for an operation other than a mounting operation. That is, a stable heat-sealing property is required for the cover tape to ensure a predetermined peeling force.

On the other hand, when the peeling force is too high, a peeling operation of the cover tape cannot be stably performed by a mounting machine. In this case, a peeling operation is sometimes interrupted, and the carrier tape vertically vibrates. Particularly, a large difference (referred to as “zip-up”) between a maximum value of the peeling force and a minimum value thereof causes the carrier tape to vibrate strongly. Due to these vibrations, the electronic components stored in the recesses may jump out from the tape package, or come into contact with a surface wall of the recess or the cover tape, and the electronic components may incur damage, deterioration, or contamination.

Further, a static electricity generated during a peeling operation of the cover tape may cause a short-circuit of the electronic components, resulting in an electrostatic discharge damage to the electronic components. In order to avoid this disadvantageous effect, the cover tape is required to have a conductivity. Furthermore, a cover tape must be transparent, to allow visual inspection of whether each electronic component contained in the tape package is appropriate to be mounted.

As described above, a cover tape for tape-packaging electronic components must satisfy all the requirements such as a heat-sealing property, a zip-up property, a conductivity, and a transparency.

2. Conventional Art

As a cover tape used for a carrier tape formed of a polyvinyl-chloride resin or a polystyrene resin which is easy to use in molding a sheet, a conventional cover tape is formed by laying on a polyester film (substrate) a thermal adhesive layer (also referred to as “heat-seal layer” or “HS layer”) formed of, e.g., polyethylene (PE), modified polyethylene, or ethylene vinyl acetate copolymer (EVA).

However, since such a cover tape has an unstable peeling force, a zip-up phenomenon may occur to vibrate the carrier tape, in the course of peeling the cover tape from the carrier tape by a mounting machine. Thus, the electronic components housed in the recesses may undesirably jump out therefrom.

There are known some other cover tapes such as a cover tape employing a substrate/soft material layer/thermal adhesive layer construction to utilize a peeling force between the soft material layer and the thermal adhesive layer, and a cover tape in which a thermal adhesive layer is suitably heat-sealed to a carrier tape by means of a cushion characteristic of a soft material layer to provide a predetermined peeling force (see, for example, the below-described Patent Documents 1 to 25).

| | |
|---|---|
| Patent Document 1: | Japanese Patent Laid-Open |
| | Publication No. 78768/1991 |
| Patent Document 2: | Japanese Patent Laid-Open |
| | Publication No. 32288/1993 |
| Patent Document 3: | Japanese Patent Laid-Open |
| | Publication No. 130899/1995 |
| Patent Document 4: | Japanese Patent Laid-Open |
| | Publication No. 172463/1995 |
| Patent Document 5: | Japanese Patent Laid-Open |
| | Publication No. 192886/1996 |
| Patent Document 6: | Japanese Patent Laid-Open |
| | Publication No. 258888/1996 |
| Patent Document 7: | Japanese Patent Laid-Open |
| | Publication No. 156684/1997 |
| Patent Document 8: | Japanese Patent Laid-Open |
| | Publication No. 201922/1997 |
| Patent Document 9: | Japanese Patent Laid-Open |
| | Publication No. 251860/1995 |
| Patent Document 10: | Japanese Patent Laid-Open |
| | Publication No. 2000-327024 |
| Patent Document 11: | Japanese Patent Laid-Open |
| | Publication No. 2001-315847 |
| Patent Document 12: | Japanese Patent Laid-Open |
| | Publication No. 2002-12288 |
| Patent Document 13: | Japanese Patent Laid-Open |
| | Publication No. 111207/1997 |
| Patent Document 14: | Japanese Patent Laid-Open |
| | Publication No. 216317/1997 |
| Patent Document 15: | Japanese Patent Laid-Open |
| | Publication No. 267450/1997 |
| Patent Document 16: | Japanese Patent Laid-Open |
| | Publication No. 96583/1995 |
| Patent Document 17: | Japanese Patent Laid-Open |
| | Publication No. 96584/1995 |
| Patent Document 18: | Japanese Patent Laid-Open |
| | Publication No. 96585/1995 |
| Patent Document 19: | Japanese Patent Laid-Open |
| | Publication No. 96967/1995 |
| Patent Document 20: | Japanese Patent Laid-Open |
| | Publication No. 295001/1996 |
| Patent Document 21: | Japanese Patent Laid-Open |
| | Publication No. 109319/1997 |
| Patent Document 22: | Japanese Patent Laid-Open |
| | Publication No. 314717/1997 |
| Patent Document 23: | Japanese Patent Laid-Open |
| | Publication No. 95448/1998 |
| Patent Document 24: | Japanese Patent Laid-Open |
| | Publication No. 115088/1999 |
| Patent Document 25: | Japanese Patent Laid-Open |
| | Publication No. 2001-348561 |

However, owing to a recent size-reduction of electronic components and a speeding-up of mounting machines, even a slightly deteriorated zip-up property may cause electronic components to fall out of a tape package, impairing an efficiency of a mounting machine. Namely, a cover tape which meets all the requirements of a heat-sealing property, a zip-up property, a conductivity, and a transparency has not been developed yet.

### SUMMARY OF THE INVENTION

The present invention is made to solve the above problems. It is an object of the present invention to provide a cover tape for tape-packaging electronic components, which satisfies all the requirements such as a stable heat-sealing property with a carrier tape, a satisfactory zip-up property, a conductivity, and a transparency.

The present invention is a cover tape for tape-packaging electronic components, for heat-sealing a carrier tape storing therein electronic components, comprising: a substrate film layer; a soft material layer; and a thermal adhesive layer; wherein the soft material layer is formed of metallocene linear low-density polyethylene; and the metallocene linear low-density polyethylene has a specific gravity in a range of from 0.888 to 0.907.

According to the present invention, when the electronic components are tape-packaged, a heat-sealing operation can be stably performed because of a satisfactory heat-sealing property with a carrier tape, which is produced by the soft material layer. When electronic components are mounted at a high speed, a satisfactory zip-up property of the cover tape can prevent the electronic components from falling out of a package, so that a deterioration in efficiency of a mounting machine can be avoided.

More specifically, due to an effect of the soft material layer, a cover tape for tape-packaging electronic components according to the present invention can be stably sealed with a carrier tape having a deformed or curved heat-sealing surface. In addition, a material of the thermal adhesive layer can be suitably selected from any material having an excellent low-temperature heat-sealing property. Further, even when small electronic components are mounted at a high speed, toughness provided by the soft material layer rarely allows a breakage of the cover tape.

In particular, it is preferable that the metallocene linear low-density polyethylene has a specific gravity in a range of from 0.892 to 0.907.

Alternatively, the present invention is a cover tape for tape-packaging electronic components, for heat-sealing a carrier tape storing therein electronic components, comprising: a substrate film layer; a soft material layer; and a thermal adhesive layer; wherein the soft material layer is formed of metallocene linear low-density polyethylene; and a softening temperature of the metallocene liner low-density polyethylene measured by a TMA method defined in JIS K7196 is in a range of from 75° C. to 97° C.

The cover tape for tape-packaging electronic components can also be stably heat-sealed with a carrier tape having a deformed or curved heat-sealing surface, due to an effect of the soft material layer. In addition, a material of the thermal adhesive layer can be suitably selected from any material having an excellent low-temperature heat-sealing property. Further, even when small electronic components are mounted at a high speed, toughness provided by the soft material layer rarely allows a breakage of the cover tape.

In a case where the thermal adhesive layer heat-seals the carrier tape, it is preferable that the thermal adhesive layer and the soft material layer are separated from each other in the heat-sealed area upon a peeling operation of the cover tape for tape-packaging electronic components from the carrier tape.

In this cover tape, it is further preferable that a peeling strength upon separation of the soft material layer from the thermal adhesive layer is in a range of from 0.1 N/mm width to 1.3 N/mm width, and that a difference between a maximum value of the peeling strength upon separation of the soft material layer from the thermal adhesive layer and a minimum value thereof is equal to or less than 0.3 N/mm width.

### BRIEF DESCRIPTION OF THE DRAWINGS

FIG. 1 is a perspective view showing an example of a tape package covered with a cover tape according to the present invention;

FIG. 2 is a sectional view showing the cover tape in one embodiment according to the present invention;

FIG. 3 is a graph showing a relationship between densities and melting points measured by a DSC method; and

FIG. 4 is a graph showing a relationship between densities and softening temperatures measured by a TMA method.

### DETAILED DESCRIPTION OF THE INVENTION

An embodiment of the present invention will described in detail with reference to the accompanying drawings.

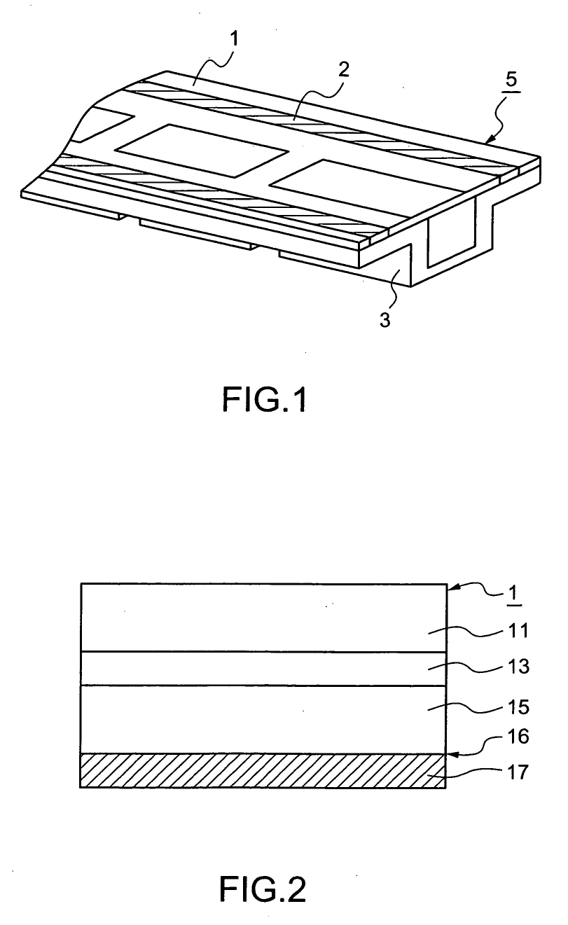

FIG. 1 is a perspective view showing a tape package including a cover tape according to the present invention.

(Tape Package)

A tape package 5 includes a carrier tape 3 (also referred to as “emboss tape”) provided with continuous recesses formed by embossing for storing therein chip-type electronic components such as IC chips and capacitors, and a cover tape 1 for heat-sealing the recesses after the electronic components are contained in the respective recesses. The electronic components housed in the tape package 5 are distributed, stored, and supplied to a machine referred to as a mounting machine. In the mounting machine, the cover tape 1 is peeled from the carrier tape 3, and the electronic components contained in the recesses in the carrier tape 3 are taken out therefrom to be mounted on an electronic circuit board or the like.

(Carrier Tape)

The carrier tape 3 may be generally formed of a material which is easy to use in molding a sheet, such as polyvinyl chloride, polystyrene, polypropylene, polyester, and polycarbonate. One of these resins may be used alone. Alternatively, these resins may be used in a form of: a copolymer resin containing these resins as a main component, a mixture thereof (including an alloy), or a laminated body composed of a plurality of layers. In particular, an unstretched film which is easy to be molded is preferred.

A thickness of a material sheet of the carrier tape 3 is generally in a range of from about 30 μm to about 1000 μm, preferably 50 μm to 700 μm, most preferably 80 μm to 300 μm. A thickness exceeding the range makes it difficult to mold the carrier tape 3, while a thickness below the range impairs a strength of the carrier tape 3. If necessary, an addition agent such as a bulking agent, a plasticizing agent, a coloring agent, an antistatic agent, and a conductive agent may be added to a material of the carrier tape 3.

The carrier tape 3 may be molded out of the material sheet by a plastic press molding method using male and female dies without heating the material sheet. The carrier tape 3 may also be molded by a vacuum forming method, an air-pressure forming method, or a vacuum air-pressure forming method, in which the material sheet is heated. Alternatively, the carrier tape 3 may be molded by using a plug-assist in combination with the above-described methods. In particular, polyvinyl-chloride resins or polystyrene resins, which are easy to be molded, are preferred.

A cover tape according to the present invention is described below.

FIG. 2 is a sectional view of a cover tape in one embodiment according to the present invention.

(Layer Structure of the Cover Tape)

The cover tape according to the present invention is formed by stacking a substrate film layer 11, a soft material layer 15, and a thermal adhesive layer 17. In order to enhance adhesion of these layers, a primer layer or an adhesion facilitating layer subjected to a treatment for facilitating an adhesion may be interposed between the respective layers. For example, FIG. 2 shows the substrate film 11, an adhesive agent layer 13, the soft material layer 15, an adhesion facilitating layer 16, and the thermal adhesive layer 17, which are stacked in this order. The thermal adhesive layer 17 may contain a conductive agent. Alternatively, a conductive agent layer may be disposed on a surface of the thermal adhesive layer 17.

The soft material layer 15 comprises linear low-density polyethylene polymerized with a metallocene catalyst (referred to as “metallocene linear low-density polyethylene” or “metallocene LLDPE”) which is limited to have a specific gravity in a range of from 0.888 to 0.907, preferably 0.892 to 0.907, and/or a softening temperature in a range of from 75° C. to 97° C. measured by a TMA method defined in JIS K7196.

The term “softening temperature” herein means a softening temperature (penetration temperature) measured by a TMA (Thermo-Mechanical Analysis) method defined in JIS K7196, and is referred to as “softening temperature measured by the TMA method” or simply as “softening temperature”.

(Features of the Invention)

As described in the explanation relating to the conventional art, there are a lot of patent documents which were made to satisfy many requirements such as a heat-sealing property, a zip-up property, a conductivity, and a transparency. However, it has been particularly still difficult to achieve both the heat-sealing property and the zip-up property. In addition, recently, a peeling operation of a cover tape is performed at a higher speed because of size-reduction of electronic components to be stored in a tape package and speeding-up of mounting machines, which makes it more difficult to simultaneously realize the heat-sealing property and the zip-up property.

A conventional cover tape has been developed as follows.

1) In order to improve the conductivity, an amount of conductive particles to be contained in a thermal adhesive layer was largely increased. However, the large amount of the conductive particles significantly impaired the transparency.

2) Then, in order to improve the transparency, a thickness of the thermal adhesive layer was drastically reduced as thin as less than about 2 μm. However, this deteriorated the heat-sealing property with a carrier tape, resulting in a deficient adhesive force (a heat-sealing strength, a peeling strength when a cover tape is peeled from a carrier tape).

3) Then, in order to improve the heat-sealing property, a thickness of a soft material layer was increased as thick as about 10 μm to about 50 μm. In conjunction therewith, LLDPE having a specific flexibility was found to be a suitable material for the soft material layer, and was used therefor. With a use of the soft material layer having a thickness in a predetermined range formed of such a material, the heat-sealing property upon a heat-sealing operation was enhanced by ensuring a satisfactory flexibleness. At the same time, in peeling the cover tape for a mounting operation under a room temperature, a toughness, i.e., a high tearing strength and an excellent zip-up property were realized. The Applicant filed Japanese Patent Application Nos. 2001-385927 and 2002-346610 pertaining to such a soft material layer.

The specific flexibility of the metallocene LLDPE is as follows. At a temperature when the carrier tape is heat-sealed with a cover tape, free movement of polymer chains enhances rubber elasticity so as to provide a high flexibility and flowability. Meanwhile, at a normal temperature upon a mounting operation, tie molecules tying polymer crystals are generated so that a pseudo-crosslinked structure is formed so as to provide an elevated toughness such as a tensile strength.

Conducting further researches and developments, the inventors of the present invention have found some conditions which can more satisfy the requirements for the conductivity, the heat-sealing property, the transparency, and the zip-up property, by precisely limiting a range of a specific gravity of the metallocene LLDPE and/or a range of a softening temperature thereof which is measured by the TMA method.

A characteristic feature of the present invention is to form the soft material layer 15 out of the metallocene LLDPE, which has a specific gravity in a range of from 0.888 to 0.907, preferably, 0.892 to 0.907, and/or a softening temperature measured by the TMA method in a range of from 75° C. to 97° C. The soft material layer 15 formed of such a material has a suitable flexibility, i.e., a cushion property. Thus, the cover tape can be tightly, stably heat-sealed to the carrier tape 3 along its surface to be heat-sealed, even when the heat-sealed surface is deformed or curved by a molding operation of the recesses for containing therein electronic components. Therefore, a material of the thermal adhesive layer 17 can be suitably selected from any material having an excellent low-temperature heat-sealing property. In this case, since a peeling strength of the heat-sealed portion of the cover tape 1 from the carrier tape 3 can be stabilized, it is possible for the tape package to resist vibrations or shocks caused when it is being stored, transported, and operated by a mounting machine. When small-sized electronic components are mounted at a high speed, a significantly small zip-up can prevent the electronic components from falling out of the tape package so as to avoid a shutdown of the mounting machine, so that a mounting operation can be expedited. In addition, in a mounting machine carrying out a mounting operation at a high speed, the cover tape 1 is generally apt to be broken when it is peeled from the carrier tape. However, a toughness of the soft material layer 15 can decrease such a trouble.

(Substrate Film)

Various materials can be used for forming the substrate film 11 of the cover tape 1 to answer a variety of purposes, provided that the material has a mechanical strength resistant to an external force applied to the material during a storage thereof, and a heat-resistance against a heat applied to the material during manufacturing and tape-packaging steps thereof. The substrate film 11 may be formed of, e.g., polyester resins comprising, e.g., polyethylene terephthalate, polybutylene terephthalate, polyethylene naphthalate, a polyethylene terephthalate-isophthalate copolymer, a terephthalic acid-cyclohexane dimethanol-ethyleneglycol copolymer, a coextruded film of polyethylene terephthalate/polyethylene naphthalate; polyamide resins; polyolefin resins comprising such as polypropylene and polymethylpentene; vinyl resins; acrylic resins such as polymethacrylate and polymethylmethacrylate; imido resins; an engineering resin; styrene resins comprising such as polycarbonate and an ABS resin; and a film formed of cellulose resins comprising cellulose triacetate or the like.

The substrate film 11 may be a copolymer resin containing the above-described resins as a main component, a mixture thereof (including an alloy), or a laminated body composed of a plurality of layers. Although the substrate film 11 may be either a stretched film or an unstretched film, an uniaxially stretched film or a biaxially stretched film is preferred in terms of a high strength. A thickness of the substrate film 11 may be generally in a range of from about 2.5 μm to about 300 μm, preferably 6 μm to 100 μm, most preferably 12 μg/m to 50 μm. A thickness exceeding the range requires a higher temperature for a heat-sealing operation upon tape-packaging, which is disadvantageous in the light of cost. On the other hand, a thickness below the range results in a deficient mechanical strength.

The substrate film 11 is a film, a sheet, or a board including at least one layer formed of the above-described resins. Herein, the term “film” is used as a generic term of these forms. In general, polyester films formed of, e.g., polyethylene terephthalate and polyethylene naphthalate are suitably used for forming the substrate film 11 in view of a cost and a mechanical strength thereof. Specifically, polyethylene terephthalate is most preferred. The soft material layer 15 is stacked on a surface of the substrate film 11. The surface to be stacked may be subjected to an adhesion facilitating treatment such as a corona discharge treatment, a plasma treatment, an ozone treatment, a frame treatment, a primer (also referred to as “anchor coat”, “adhesion accelerator”, “adhesion facilitating agent”) application treatment, a preheat treatment, a dust removing treatment, a vapor deposition treatment, and an alkali treatment. If necessary, an addition agent such as a bulking agent, a plasticizing agent, a coloring agent, and an antistatic agent may be added to the resin film 11.

(Adhesive Agent Layer)

The adhesive agent layer 13 may be interposed between the substrate film 11 and the soft material layer 15, according to need. The adhesive agent layer 13 enables the substrate film 11 and the soft material layer 15 stacked thereon to be tightly adhered to each other. A provision of the adhesive agent layer 13 allows the cover tape 1 to have an enhanced breakage-proof property because of a synergy effect of a mechanical strength of the substrate film 11 and a toughness of the soft material layer 15.

(Soft Material Layer)

As a material for the soft material layer 15, polyethylene resins formed of, e.g., low density polyethylene (LDPE) and linear low-density polyethylene (LLDPE), and ethylene copolymers, each of which has a high flexibility and tearing strength, have been used. In the present invention, metallocene LLDPE of a lower density is used. One type of the LLDPE is polymerized with a Ziegler-type catalyst, and another type of the LLDPE is polymerized with a metallocene catalyst, which is called “metallocene LLDPE”. The inventors of the present invention have found that, since a molecular structure of the metallocene LLDPE can be controlled to increase its uniformity, a distribution range of a molecular weight can be reduced (narrowed) whereby the metallocene LLDPE can exhibit an especially unique performance.

(Metallocene LLDPE)

As described above, a molecular weight distribution of the metallocene LLDPE can be controlled to be narrower. Thus, disadvantages such as: stickiness caused by a low crystallization, needless lowering of a melting point, and smoke produced upon a molding operation can be restrained in the metallocene LLDPE, while the metallocene LLDPE displays an elastomeric behavior. Metallocene catalysts include, for example, a single-site catalyst (SSC), and a constrained geometry catalyst (CGC). The metallocene catalyst is a generic term of a catalyst in which at least one or more ligand(s) having a cyclopentadienyl skeleton is coordinated to a quadrivalent transition metal such as titan, zirconium, nickel, palladium, hafnium, niobium, and platinum.

As a ligand having a cyclopentadienyl skeleton, there are, for example, cyclopentadienyl group; alkyl mono-substituted cyclopentadienyl group such as methyl cyclopentadienyl group, ethyl cyclopentadienyl group, n- or i-propyl cyclopentadienyl group, n-, i-, sec-, tert-butyl cyclopentadienyl group, hexyl cyclopentadienyl group, and octyl cyclopentadienyl group; alkyl di-substituted cyclopentadienyl group such as dimethyl cyclopentadienyl group, methyl ethyl cyclopentadienyl group, methyl propyl cyclopentadienyl group, methyl butyl cyclopentadienyl group, methyl hexyl cyclopentadienyl group, ethyl butyl cyclopentadienyl group, ethyl hexyl cyclopentadienyl group; alkyl poly-substituted cyclopentadienyl group such as trimethyl cyclopentadienyl group, tetramethyl cyclopentadienyl group, and pentamethyl cyclopentadienyl group; cyclo substituted cyclopentadienyl group such as methyl cyclo hexyl cyclopentadienyl group; indenyl group; 4, 5, 6, 7-tetrahydro indenyl group; and fluorenyl group.

As a ligand other than that having a cyclopentadienyl skeleton, there are, for example, monovalent anion ligand such as chlorine and bromine, bivalent anion chelate ligand, hydrocarbon group, alkoxide, amide, arylamide, aryloxide, phosphide, arylphosphide, silyl group, and substituted silyl group. The number of carbon atoms of a typical type of the above hydrocarbon group is 1 to 12 in general. For example, there are methyl group, ethyl group, propyl group, butyl group, isobutyl group, amyl group, isoamyl group, hexyl group, heptyl group, octyl group, nonyl group, decyl group, cesyl group, alkyl group such as 2-ethyl hexyl group, cyclo hexyl group, cyclo alkyl group such as cyclo pentyl group, phenyl group, aryl group such as tolyl group, benzyl group, an aralkyl group such as neophyl group, and nonyl phenyl group.

As a metallocene compound having a ligand of a cyclopentadienyl skeleton, there are, for example, cyclopentadienyl titanium tris(dimethyl amide), methyl cyclopentadienyl titanium tris(dimethyl amide), bis (cyclopentadienyl) titanium dichloride, dimethyl silyl tetramethyl cyclopentadienyl-tert-butylamide zirconium dichloride, dimethyl silyl tetramethyl cyclopentadienyl-p-n-butylphenyl amide zirconium dichloride, methylphenylsilyltetrarmethyl cyclopentadienyl-tert-butylamide hafnium dichloride, dimethylsilyltetramethyl cyclopentadienyl-tert-butylamide hafnium dichloride, indenyl titanium tris(dimethyl amide), indenyl titanium tris(diethyl amide), and indenyl titanium bis (di-n-butyl amide) indenyl titanium bis (di-n-propyl amide).

In place of the metallocene catalysts including the foregoing quadrivalent transition metal, these polymerizations may be carried out by using as a co-catalyst catalysts containing a methyl aluminoxane compound, a boron compound, and so on. In this case, a ratio of these catalysts relative to the metallocene catalysts is preferably 1 to 1,000,000 molar times.

Although a non-crosslinking resin, the metallocene LLDPE is excellent in flexibility. The reason for this is considered that there exists polymer chains (tie molecules) that tie crystals. Irrespective of a room temperature or a molding temperature, a crosslinked rubber elastic member has a three-dimensional network structure between polymer molecules, which improves a flexibility but degrades a flowability. On the other hand, similarly to the general polyethylene, in the metallocene LLDPE, at a high molding temperature, polymer chains can freely move to provide a high flowability. Meanwhile, at a normal temperature, the tie molecules that tie polymer crystals are generated simultaneously with a crystal growth, so that a pseudo-crosslinked structure is formed. Thus, it is considered that a rubber elasticity is improved to provide a satisfactory flexibility.

The metallocene LLDPE is a copolymer of, for example, ethylene and olefin having more than two carbon atoms as a comonomer. Preferably, the metallocene LLDPE is a copolymer of ethylene and linear α-olefin, branched α-olefin, or α-olefin substituted with an aromatic nucleus, having 3 to 18 carbon atoms.

The linear mono-olefin includes, for example, propylene, 1-butene, 1-pentene, 1-heptene, 1-hexene, 1-octene, 1-nonene, 1-decene, 1-undecene, 1-dodecene, 1-tetradecene, 1-hexadecene, and 1-octadecene.

The branched mono-olefin includes 3-methyl -1-butene, 3-methyl -1-pentene, 4-methyl-1-pentene, 2-ethyl-1,2-ethyl-1-hexene, 2,2,4-trimethyl-1-pentene, and so on.

The mono-olefin substituted-with an aromatic nucleus includes styrene, for example. Further, cyclopentene, cycloheptene, norbornene, 5-methyl-2-norbornene, tetra cyclododecene, 2-methyl-1, 4, 5, 8-dimethano-1, 2, 3, 4, 4a,5,8,8a-octahydronaphthalene, styrene, vinyl cyclohexane, and so on are included.

One of these comonomers or a combination of two or more kinds thereof is copolymerized with ethylene. Polyethylenes such as butadiene, isoprene, 1,4-hexadiene, dicyclopentadiene, and 5-ethylidene-2-norbornene may be added to the copolymerization. The content of α-olefin in the thus obtained copolymer is in a range of from 1 mol % to 10 mol %, preferably 1.5 mol % to 7 mol %.

(Density of Soft Material Layer)

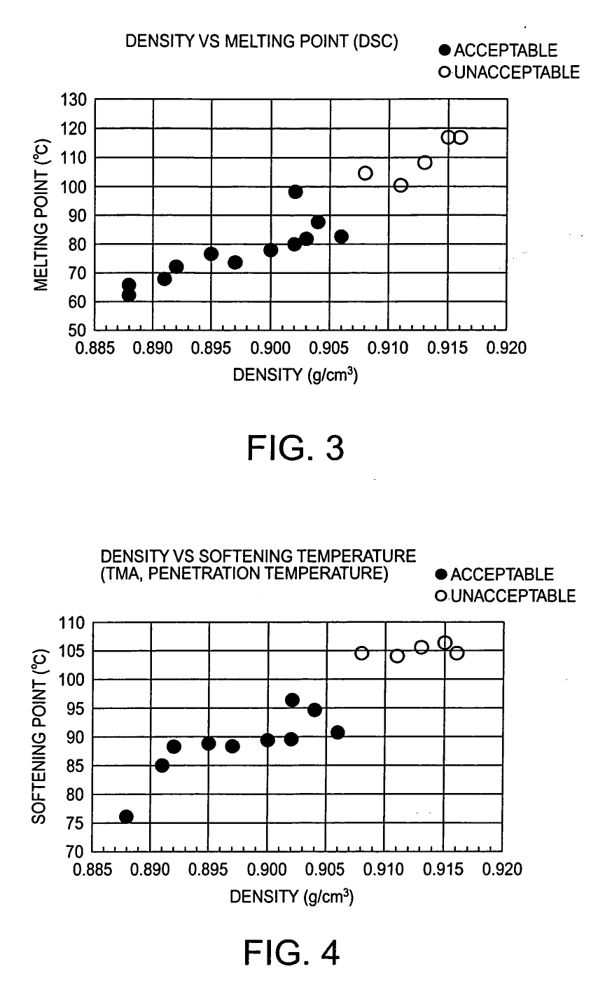

FIG. 3 is a graph showing a relationship between densities and melting points measured by a DSC method.

As shown in FIG. 3, it is preferable that a density of the soft material layer 15 measured based on a definition of JIS-K7112 is in a range of from 0.888 to 0.907, particularly 0.892 to 0.907. A melting point of the soft material layer 15 measured in accordance with a DSC method (Differential Scanning Calorie Analysis) defined in JIS-K7121 is in a range of from 60° C. to 99° C., preferably 70° C. to 87° C.

The soft material layer 15 having a density below the above-described range may have a melting point less than 60° C. In this case, the soft material layer 15 has a poor heat resistance, although an improved heat sealing property is provided thereto. Due to this poor heat resistance of the soft material layer 15, the cover tape may be melted by an ambient temperature during a storage or transportation of the tape package. That is, a so-called blocking phenomenon is prone to occur. On the other hand, the soft material layer 15 having a density exceeding the above range has an enhanced heat resistance, but is inferior in a sealing property at a lower temperature.

Herein, a melting point measured by the DSC method means a lowest melting peak temperature in a DSC curve which is obtained in accordance with a method defined in JIS-K7112.

(Softening Temperature of Soft Material Layer Measured by TMA Method)

FIG. 4 is a graph showing a relationship between densities and softening temperatures measured by a TMA method. A softening temperature (penetration temperature) measured by a TMA method is a temperature measured in accordance with a method defined in JIS-K7196 (TMA method, thermo-mechanical analysis).

As shown in FIG. 4, it is preferable that a softening temperature measured by the TMA method of the soft material layer 15 is in a range of from 75° C. to 97° C., particularly 85° C. to 97° C.

Since a soft material layer 15 having a softening temperature measured by the TMA method below the above-described range lacks in heat resistance, a cover tape including the soft material layer 15 is liable to flow to form a mold flash by an ambient temperature during a storage or transportation of the tape package. Further, when the tape package is formed, the cover tape may be excessively softened or melted by a heat sealing temperature so as to flow to form a large mold flash. That is, it is impossible to stably provide a satisfactory sealing strength. On the other hand, a soft material layer 15 having a softening temperature exceeding the above-described range has an improved heat resistance, but has a deteriorated flexibility and cushion property, which results in an inferior zip-up property.

A correlation between a density of the soft material layer 15 and a softening temperature thereof measured by the TMA method is not clearly understood. However, it is possible to obtain a significantly desirable soft material layer 15, by simultaneously satisfying the requirements of a suitable density range and of a suitable softening temperature range measured by the TMA method.

A thickness of the soft material layer 15 may be in a range of from 10 μm to 100 μm, preferably 10 μm to 50 μm. A soft material layer 15 having a larger thickness lacks in cushion property. A soft material layer 15 having a smaller thickness has an excessive cushion property and lacks in a thermal conductivity. Then, since a large amount of calorie is needed for a sealing operation, such a soft material layer 15 is disadvantageous in cost.

(Stacking Process)

The soft material layer 15 may be stacked on the substrate film 11 by known methods such as a dry laminating method, an extrusion laminating method, and an extrusion coating method. Preferably, an extrusion coating method may be employed.

(Dry Laminating Method)

In order to perform the stacking process by a dry laminating method, a dry laminating method in a narrow sense and a non-solvent laminating method may be employed. In these laminating methods, an adhesive agent to be contained in the adhesive agent layer 13 may be a hardening adhesive agent which is hardened by a heat or an ionizing radiation such as an ultraviolet ray and an electron ray. To be specific, a thermosetting adhesive agent may be employed which is formed by hardening polyurethane resins, polyester resins, acryl resins, or modifications of these resins as a principal component, by using isocyanates or amines.

(Adhesive Agent)

An adhesive agent composition is obtained by dissolving or dispersing, in an organic solvent, a base resin formed of, e.g., polyether polyol, polyester polyol, and polyacrylate polyol; and a hardening agent formed of, e.g., tolylene diisocyanate, diphenylmethane diisocyanate, hexamethylene diisocyanate, and xylylene diisosianate. Then, the adhesive agent composition is applied to the substrate film 11 by a coating method such as a roll coating and a gravure coating. After the solvent is dried, the soft material layer 0.15 is stacked on the substrate film 11, and the stacked soft material layer 15 and the substrate film 11 are pressurized. Subsequently, the soft material layer 15 and the substrate film 11 are maintained at a temperature of 30° C. to 120° C. for some hours or some days. Thus, the solvent is hardened. It is preferable that a surface of the soft material layer 15 facing the adhesive agent layer is previously subjected to an adhesion facilitating treatment such as a corona discharge treatment, a plasma treatment, an ozone treatment, and a frame treatment.

(Extrusion Laminating Method/Extrusion Coating Method)

In order to perform the stacking process by an extrusion method, an extrusion coating (also referred to as “EC” and “extrusion coating method”), a coextrusion coating (“Co-EC”), an extrusion lamination (referred to as “extrusion laminating method” and “poly-sandwiching method”), or a coextrusion lamination (referred to as “coextrusion laminating method”) may be employed.

(Extrusion Laminating Method)

According to the extrusion laminating method, an adhesion accelerator called an anchor coating agent is firstly applied to the substrate film 11 and is then dried. Following thereto, an extrusion resin is extruded on the anchor coating agent, and the soft material layer 15 which has been already formed as a film is laminated thereon. In this manner, the substrate film 11/the anchor coating agent/the extrusion resin/the soft material layer 15 are adhesively stacked. This method is referred to as “poly-sandwiching” by those skilled in the art. In this method, the extrusion resin layer constitutes a part of the soft material layer 15.

(Extrusion Coating Method)

According to the extrusion coating method, an adhesion accelerator called an anchor coating agent is also firstly applied to the substrate film 11 and is then dried. Following thereto, a resin of the soft material layer 15 is extruded as an extrusion resin and stacked on the anchor coating agent. In this manner, the substrate film 11/the anchor coating agent/the soft material layer 15 are adhesively stacked. This method is referred to as “EC” or “extrusion coating method” by those skilled in the art. In this method, the extrusion resin layer is simultaneously deposited and stacked on the anchor coating agent to constitute a part of the soft material layer 15.

(Coextrusion Coating Method)

It is possible to employ a coextrusion coating method in which a plurality of extrusion resin layers are formed. This method is referred to as “coextrusion coating” (Co-EC) by those skilled in the art. A plurality of extrusion resins are heated and melted by separate extruders. The respective molten resins are introduced to a T-shaped dice for coextrusion to join together. The resins are extruded as stacked layers like a curtain, while being extended in a necessary width direction. The plural resin layers can adopt various constructions, e.g., two layers formed of two kinds of resins, three layers formed of three kinds of resins, three layers formed of two kinds of resins, and five layers formed of three kinds of resins. In these cases, a main resin layer or a most thickened layer is formed of a resin (metallocene LLDPE) of the soft material layer 15.

(Extrusion Resin)

Extrusion resins used in the extrusion lamination or coextrusion lamination may be olefin resins comprising, e.g., polyethylene (low density, linear), a copolymer resin comprising, e.g., an ethylene-vinyl acetate (EVA) copolymer, ionomer resins, acid-modified polyolefin resins, and so on. These resins may be used individually. Alternatively, these resins may be used as a blend of more than one kinds thereof, or a unit of layers. If desired, an addition agent such as a coloring agent, a pigment, an extender, a bulking agent, a lubricant, a plasticizing agent, a surface active agent, and a filler may be added to the extrusion resins, provided that the addition agent has no impact on essential functions.

A thickness of the resin layer used for an extrusion lamination may be in a range of from 5 μm to 100 μm, preferably 10 μm to 80 μm, most preferably 10 μm to 50 μm.

(Anchor Coating Agent)

As described above, in the extrusion coating method and the like, an adhesion accelerator called an anchor coating agent is generally used to securely adhere an extrusion resin to the substrate film 11. An anchor coating agent formed of, e.g., alkyltitanate, isocyanates, and polyethylene imines is applied to the substrate film 11 by a known coating method such as a roll coating and a gravure coating, and is then dried. A thickness of the anchor coating agent is generally in a range of from about 0.01 μm to about 10.0 μm, preferably 0.1 μm to 5.0 μm. In place of the application of the anchor coating agent, an adhesion facilitating treatment such as a corona discharge treatment, a plasma discharge treatment, and an ozone gas treatment may be carried out.

The soft material layer 15 formed and stacked by the extrusion coating method and the soft material layer 15 formed by the extrusion laminating method or the dry laminating method have substantially the same functions and effects, only the stacking manners being different from each other. The most suitable stacking method can be optionally selected depending on the number of lots in a product, a structure of layers, thicknesses of the respective layers, and so on.

It is easy to form a low density resin layer by the extrusion coating method. Further, in the extrusion coating method, the soft material layer 15 (metallocene LLDPE) is rapidly cooled at the time of deposition so that a degree of crystallinity is low. Thus, an enhanced flexibility can be imparted to the soft material layer 15. As explained above, similarly to the general polyethylene, in the metallocene LLDPE, at a high molding temperature, polymer chains can freely move to provide a high flowability. Meanwhile, at a room temperature, tie molecules that tie polymer crystals are generated simultaneously with a crystal growth so as to improve a tensile strength and a toughness of the soft material layer 15. Therefore, since the soft material layer 15 has an excellent flowability at a high temperature for heat-sealing the carrier tape 3, the cover tape 1 can be suitably heat-sealed to the carrier tape 3 along a sealed portion thereof. On the other hand, at a normal temperature during a mounting operation, a high toughness and tearing strength of the soft material layer 15 rarely allows the cover tape 1 to be broken. Thus, an efficiency of a mounting machine is prevented from being lowered. As previously cited, by limiting a specific gravity and/or a softening temperature measured by the TMA method, the foregoing effects can be further enhanced.

(Material of Thermal Adhesive Layer)

Next, the thermal adhesive layer 17 is disposed on the soft material layer 15. The thermal adhesive layer 17 includes a thermoplastic resin and conductive particles. As needed, an addition agent such as a dispersing agent, a bulking agent, a plasticizing agent, a coloring agent, and an antistatic agent may be added in the thermal adhesive layer 17. The thermoplastic resin can be formed of one or a combination of acid-modified polyolefin resins, an ethylene-(meta)acrylic acid copolymer, polyester resins, vinyl resins, acrylic resins comprising such as acryls and methacryls, polyurethane resins, silicone resins, and rubber resins. In the light of a dispersing property of the conductive particles and an adhesiveness to the carrier tape, any one of acrylic resins, polyester resins, polyurethane resins, a vinyl chloride-vinyl acetate copolymer, an ethylene-vinyl acetate copolymer; or a resin containing these materials as a principal component is preferred. As mentioned above, due to an effect of the soft material layer 15, the cover tape can be heat-sealed to the carrier tape. Thus, the thermoplastic resin used for the thermal adhesive layer 17 can be optionally selected, taking into consideration compatibility of the thermal adhesive layer 17 with the carrier tape.

(Conductive Agent Added in Thermal Adhesive Layer)

In general, an innermost layer which may come into direct contact with electronic components is subjected to an antistatic treatment by mixing therein: an antistatic agent such as a surface active agent; conductive particles including conductive sulfide such as conductive zinc sulfide; or a conductive agent including, e.g., metallic oxide such as tin oxide, zinc oxide, indium oxide, and titanium oxide, conductive carbon particles, a silicon organic compound, and surface metal plated particles.

Preferably, metallic oxide particles formed of, e.g., tin oxide doped with antimony, indium oxide doped with tin, and other tin oxides, conductive carbon particles, an antistatic-type silicon organic compound, or surface metal plated particles are used. Although the carbon particles and the surface metal plated particles are opaque, these particles of a smaller diameter can be used at an amount capable of allowing a transparency. These particles may be used in combination with other transparent conductive particles. It is preferable that a primary particle of each conductive particle has an average particle diameter in a range of from 0.01 μm to 10 μm. The conductive particle may be formed in a needle shape, a circular shape, a scale shape, or an angular shape, but a needle shape is preferred in terms of a transparency.

A content by mass of the conductive particles contained in the thermal adhesive layer 17 may be in a range of from 1.0 to 5.0 with respect to 1 of the thermoplastic resin. Preferably, the content of the conductive particles is in a range of from 1.5 to 3.0 with respect to 1 of the thermoplastic resin. When a content of the conductive particles is below the above-described value, no effect is produced by the mixed conductive particles. On the other hand, a content exceeding the above value produces an adverse effect in transparency and adhesiveness. The term “content” means a content by mass, unless otherwise noted.

The thermoplastic resin(s), the conductive particles, and the addition agent if needed are dispersed or dissolved in a solvent to form an application liquid. The application liquid is applied to the soft material layer 15 by a known coating method such as a roll coating, a reverse roll coating, a gravure coating, a gravure reverse coating, and a comma coating, and is then dried. Thus, the thermal adhesive layer 17 is formed.

A thickness of the thermal adhesive layer 17 is in a range of from about 0.05 μm to about 3.0 μm. A thermal adhesive layer 17 of a thickness below 0.05 μm cannot exert a satisfactory antistatic effect, while a thermal adhesive layer 17 of a thickness above 3.0 μm degrades not only a transparency of the laminated body but also a heat-sealing property to the carrier tape.

A surface of the substrate film 11 opposite to the surface facing the soft material layer 15 may have an antistatic material layer, or may be subjected to an antistatic treatment. The same antistatic material as the conductive agent added in the thermal adhesive layer 17 may be employed. The antistatic treatment may be carried out by a known coating method.

(Surface Resistance Value)

A preferable surface resistance value of the thermal adhesive layer 17 is in a range of from 10⁵Ω to 10¹²Ω at a temperature of 22° C. and a relative humidity of 60%. In this case, an excellent static property can be provided. That is, a static decay time necessary for reducing a charge of 5000 V by 99% is as short as equal to or less than 2 seconds, at a temperature of 23±5° C. and a relative humidity of 12±3%. A surface resistance value exceeding 10¹²Ω significantly deteriorates a dissipation effect of the static charge, and thus it becomes difficult to protect electronic components from an electrostatic discharge damage. Meanwhile, a surface resistance value below 10⁵Ω allows electricity to flow from outside to electronic components through the cover tape, so that the electronic components may possibly be electrically damaged.

The surface resistance value is measured by means of Hiresta-UP (manufactured by Mitsubishi Chemical Corporation, trade name) at a temperature of 22° C. and a relative humidity of 40%. The static decay time is measured by means of STATIC-DECAY-METER-406C (manufactured by Electro-Tech-Systems, Inc., trade name), in which a time necessary for reducing a charge of 5000 V by 99% is measured in compliance with MIL-B-81705C, at a temperature of 23±5° C. and a relative humidity of 12±3%. Values measured under the above-described conditions are stated hereinbelow.

(Adhesion Facilitating Treatment for Soft Material Layer)

When the thermal adhesive layer 17 is disposed on a surface of the soft material layer 15, the surface of the soft material layer 15 is preferably subjected to an adhesion facilitating treatment. The adhesion facilitating treatment includes a provision of a primer layer for encouraging an adhesion of the soft material layer 15 to the thermal adhesive layer 17, a corona discharge treatment, a plasma treatment, an ozone gas treatment, a frame treatment, and a preheating treatment. A provision of a primer layer and a corona discharge treatment are preferred. A primer layer may be formed of, for example, a polyurethane resin, a polyester resin, polyvinylchloride resins, polyvinyl acetate resins, a vinyl chloride-vinyl acetate copolymer, an acrylic resin, polyvinyl alcohol resins, a polyvinyl acetal resin, a copolymer of ethylene and vinyl acetate or acrylic acid, a copolymer of ethylene and styrene and/or butadiene, and an epoxy resin. A rubber such as a butadiene rubber and an acrylic rubber or an elastomer may be added to these resins.

These resins are dissolved or dispersed in a suitable solvent to obtain an application liquid. The application liquid is applied to the surface of the soft material layer 15 by a known coating method, and is dried to form a primer layer. A reaction initiator, a hardening agent, or a crosslinking agent combined with monomer, oligomer, or prepolymer may be added to these resins. Alternatively, a base resin and a hardening agent may be combined to react to each other by an aging treatment during and after a drying step. A thickness of the primer layer is from about 0.05 μm to about 3.0 μm, preferably 0.1 μm to 2.5 μm. Since the primer layer has only a small thickness, rigidity of the whole cover tape is not increased thereby, which is more suitable.

(Corona Treatment)

A corona discharge treatment is a treatment carried out by a corona surface treatment apparatus which applies a high voltage to a counter electrode and a discharge electrode so as to generate a corona discharge. In the corona discharge treatment, an object to be processed is exposed to a corona discharge flame from the discharge electrode to modify a surface thereof by oxidation so as to enhance a hydrophilicity of the surface. The surface of the soft material layer 15 is subjected to a corona treatment so as to obtain a surface tension of equal to or more than about 0.00036 N/cm, preferably equal to or more than 0.00040 N/cm, most preferably equal to or more than 0.00043 N/cm. When a surface of the soft material layer 15 is subjected to a corona discharge treatment, the thermal adhesive layer 17 is adhered thereto in a more stable manner. As stated above, since a thickness of the primer layer is almost negligible, a needless increase in rigidity of the whole cover tape can be avoided, which is more preferable.

(Conductive Agent Layer on Surface of Thermal Adhesive Layer)

In place of the thermal adhesive layer formed of a thermoplastic resin containing a conductive agent, a conductive agent layer 19 may be disposed on a surface of a thermoplastic resin. The same thermoplastic resins as those used in the thermal adhesive layer 17 may be used in this case. A surface of the thermoplastic resin layer facing the soft material layer 15 may be subjected to an adhesion facilitating treatment, when the thermoplastic resin layer is formed. A conductive agent forming the conductive agent layer 19 to be disposed on a surface of the thermoplastic resin may be the same conductive agent as the above-described one contained in the thermal adhesive layer 17.

In order to dispose the conductive agent layer 19 on a surface of the thermoplastic resin, an ink formed by dispersing a conductive agent (conductive filler) in a solvent that can dissolve at least the thermal adhesive layer 17 is applied to a surface of the thermoplastic resin of the thermal adhesive layer 17, and an end of the conductive filler is buried in the thermal adhesive layer, for example.

When a blended solvent including a good solvent effective in dissolving the thermoplastic resin of the thermal adhesive layer 17 and a poor solvent ineffective in solving the same is used, it is possible to control a specific manner for burying the end of the conductive filler in the thermal adhesive layer 17. Further, in order to efficiently raise conductivity of an opened surface of the thermoplastic resin of the thermal adhesive layer 17 with a small amount of the conductive filler, it may be possible to dispose the conductive filler to be exposed to the opened surface of the thermoplastic resin. Alternatively, the conductive filler may be disposed in such an inclined manner that the content thereof increases near the opened surface of the thermal adhesive layer (thermoplastic resin).

(Transparency)

A total light transmissivity of the cover tape is equal to or more than 10%, preferably equal to or more than 50%, most preferably equal to or more than 75%. A haze of the cover tape is preferably equal to or less than 50%. Under these conditions, each electronic component housed in each recess of the tape package can be easily checked with the eye or some machine. A transparency of equal to or less than 10% in a total light transmissivity makes it difficult to check electronic components inside the tape package. It goes without saying that the total light transmissivity is a value smaller than 100%, and that the haze is a value larger than 0. The haze and the total light transmissivity are measured by means of, for example, a color computer SM-44C (manufactured by Suga Test Instruments, Co., Ltd., trade name).

As has been explained, the cover tape 1 in this embodiment preferably includes the substrate film 11 having a thickness of from 12 μm to 50 μm, the adhesive agent layer 13 having a thickness of from 0.05 μm to 20 μm, the soft material layer 15 formed of a particular resin having a thickness of from 10 μm to 50 μm, and the thermal adhesive layer 17 having a thickness of from 0.05 μm to 3.0 μm. In addition, the adhesion facilitating layer 16 is interposed between the soft material layer 15 and the thermal adhesive layer 17, when needed. The adhesion facilitating layer 16 is a primer layer or a corona-treated layer having a thickness of from 0.05 μm to 1.0 μm.

The cover tape 1 as constituted above will not be heat-melted or heat-shrunk when it comes into contact with a sealing bar of a high temperature for heat-sealing the carrier tape 3 containing electronic components. Due to a cushion property of the soft material layer 15, the cover tape 1 can be stably heat-sealed to a carrier tape that can be easily deformed. In addition, when the cover tape 1 is peeled from the carrier tape by a mounting machine, the cover tape 1 is only rarely broken. Further, a small zip-up, that is, a small difference between a maximum value of the peeling strength of the cover tape 1 and a minimum value thereof can restrain the electronic components from falling out of the tape package.

A substrate film 11 of a thickness equal to or larger than 50 μm, an adhesive agent layer of a thickness equal to or larger than 20 μm, and a soft material layer of a thickness equal to or larger than 50 μm may increase rigidity of the cover tape, and may inhibit a transmission of heat required for the thermal adhesive layer. Thus, a temperature of the sealing bar must be set higher. This causes a deformation and a dimensional change of the carrier tape 3 whose heat resistance is inferior, which results in displacement of the electronic components to be mounted. In contrast, a substrate film 11 of a thickness equal to or smaller than 12 μm, an adhesive agent layer of a thickness equal to or smaller than 2 μm, and a soft material layer of a thickness equal to or smaller than 10 μm may deteriorate a mechanical strength of the cover tape 1 so that the cover tape 1 is undesirably liable to be broken. Even when a peeling strength of the cover tape 1 is appropriate, a larger zip-up may cause electronic components to fall out of the carrier tape, and thus disturb a stable and rapid mounting operation. Researches conducted by the inventors of the present invention has shown that the zip-up has a relationship with rigidity of the cover tape. That is, it has been found that, when the rigidity is low within a predetermined range, the zip-up is also low.

(Zip-Up)

The larger zip-up (difference between a maximum value of the peeling force and a minimum value thereof) is not preferable because the larger zip-up may cause the carrier tape to vibrate so that the contents may be fallen therefrom. A preferable zip-up is equal to or less than 0.3 N, more preferably equal to or less than 0.15 N. The substantially zero zip-up allows the carrier tape peeled off from the cover tape to smoothly run, and thus a further speeding-up of a filling machine can be realized.

Rigidity of the cover tape was measured by means of a Loop Stiffness Tester (manufactured by Toyo Seiki Seisakusho, Ltd.). The timing when a sample of 15 mm in width and 62 mm in loop length in terms of a film-deposition direction was pushed by 5 mm was represented by t=0, and a stiffness strength f was measured after 3 minutes, 5 minutes, 10 minutes, and 30 minutes, respectively. A maximum stiffness strength during the measurement was taken as an initial impact value. A regression line f=−at+b was calculated by the least square method, based on t (3≦t≦30) and f, so as to obtain a and b. When the initial impact value is larger than 50 g, rigidity of the cover tape is so high that a zip-up is also large. When the initial impact value is equal to or smaller than 4 g, an uneven heat-sealing may affect the peeling strength so as to increase the zip-up. When a takes a large value, it means that a variation of f is large and a zip-up is also large. When a takes a small value, it means that a variation of f is small, which is preferable. When b is larger than 50 g, an initial impact value tends to be large and excessively high rigidity increases a zip-up. When b is smaller than 4 g, an initial impact value tends to be small, and an uneven heat-sealing directly affects the peeling strength so as to increase a zip-up.

(Peeling Strength)

When the cover tape 1 is heat-sealed to the carrier tape 3, the soft material layer 15 serves as a cushion for uniformly, tightly adhering the sheets (tapes) to each other. A peeling strength when the heat-sealed cover tape 1 is peeled from the carrier tape 3 is preferably in a range of from about 0.1 N/mm width to about 1.3 N/mm width.

When a peeling strength of the cover tape 1 from the carrier tape 3 is below 0.1 N/mm width, the cover tape 1 may be peeled from the carrier tape 3 during a transportation of the tape package so as to possibly cause the contents therein to fall out from the tape package. A peeling strength exceeding 1.3 N/mm width may cause the carrier tape 3 to vibrate when the cover tape is peeled therefrom, so that the electronic components may be fallen out of the tape package.

The peeling strength was measured at a peeling velocity of 300 mm/minute and a peeling angle of 180°, by means of PEEL-BACK-TESTER (Vanguard Systems, Inc., trade name) under a condition wherein the temperature was 23° C. and the relative humidity was 40%. Depending on characteristics or kinds of the soft material layer 15 and the thermal adhesive layer 17, it is selectively possible to generate an interlaminar separation between the soft material layer 15 and the thermal adhesive layer 17, or a cohesion failure within the thermal adhesive layer 17. These peeling manners can be suitably selected by controlling the heat-sealing conditions. That is, when the carrier tape 3 and the cover taped 1 are completely fusion-bonded to each other with a high heat-sealing temperature, a long heating period, and a high pressure, an interlaminar separation between the soft material layer 15 and the thermal adhesive layer 17 can be utilized. On the other hand, when the carrier tape 3 and the cover tape 1 are incompletely fusion-bonded to each other with a low heat-sealing temperature, a short heating period, or a low pressure, it may be possible to achieve an interfacial separation between the thermal adhesive layer 17 and the carrier tape 3 (herein, the term “interfacial separation” means a separation between the thermal adhesive layer 17 and the carrier tape 3, which is discriminated from the term “interlaminar separation” between the soft material layer 15 and the thermal adhesive layer 17), and a zip-up smaller than 0.3 N. However, the latter operation steps cannot be regularly, stably performed because of severe heat-sealing conditions. In the present invention, since the adhesive layer 17 formed of a resin selected from a wide range can be used, the carrier tape can be sufficiently heat-sealed, and an interlaminar separation between the soft material layer 15 and the thermal adhesive layer 17 can be securely utilized.

As described above, the interlaminar separation between the soft material layer 15 and the thermal adhesive layer 17 can be realized by a sufficient heating and pressurization during a heat-sealing operation. For example, the interlaminar separation can be achieved when a heat-sealing operation is carried out at a heating temperature of 100° C. to 200° C., a heating period of 0.05 seconds to 2.0 seconds, and a pressurization of 7 N/cm² to 30 N/cm². When measured at a peeling angle of 180°, a peeling strength of the interlaminar separation between the soft material layer 15 and the thermal adhesive layer 17 is lower than a peeling strength between the thermal adhesive layer and the carrier tape. That is, a sufficient heating operation enables an interlaminar separation between the soft material layer and the thermal adhesive layer.

Since the soft material layer 15 and the thermal adhesive layer 17 are separated from each other, the cover tape according to the present invention is not vulnerable to the heat-sealing conditions. Accordingly, the cover tape and the carrier tape can be sufficiently heated to be stably heat-sealed to each other, and can be separated from each other at a stable peeling strength.

A surface of the substrate film 11 on the opposite side to the thermal adhesive layer 17, i.e., an outermost surface may be subjected to an antistatic treatment, according to need, by using, e.g., a surface active agent, a silicon organic compound, and conductive particles such as conductive carbon black, metallic vapor deposition, and metallic oxide. Due to this treatment, attachment of dusts to the surface of the substrate film 11, and generation of static electricity in the surface caused by a contact with another surface can be prevented.

### EXAMPLE 1

The substrate film 11 was formed of Tetoron film of F-type (manufactured by Teijin Ltd., trade name of polyethylene terephthalate) having a thickness of 16 μm. An anchor coating agent formed of 5 parts by mass of tetraisobutyltitanate and 95 parts by mass of n-hexan was applied on the substrate film 11 by a roll coating method and was dried such that the dried anchor coating agent had a thickness of 0.01 μm. Then, the metallocene LLDPE (density: 0.892) was heated and melted by an extruder, and was extended by a T-shaped dice in a necessary width direction to be extruded as the soft material layer 15 like a curtain having a thickness of 35 μm. The substrate film 11/the anchor coating agent layer/the soft material layer 15 were sandwiched between a rubber roller and a cooled metal roller, and the three stacked layers were adhered. Subsequently, a surface of the soft material layer 15 was subjected to a corona treatment by a known corona treatment apparatus to obtain a surface tension of 0.00043 N/cm. A composition for forming the thermal adhesive layer 17 was applied to the corona-treated surface by a gravure reverse coating method and was dried such that the dried composition had a thickness of 2.0 μm. Thus, the cover tape of Example 1 was provided.

As the composition for forming the thermal adhesive layer 17, 100 parts by mass of DIANAL BR-83 (manufactured by Mitsubishi Rayon Co., Ltd., trade name of acrylic resin), 150 parts by mass of antimony dope tin oxide (conductive particles, manufactured by Ishihara Sangyo Kaisha, Ltd., 0.32 μm in 50% particle diameter), and 750 parts by mass of mixed solvent (methylethylketone and toluene in equal proportions) were blended to form a composition having the dispersed particles and the dissolved resin.

### EXAMPLES 2 TO 10

The cover tapes of Examples 2 to 10 were formed of the same materials as those of Example 1, except the metallocene LLDPE (abbreviated as “LL” in Tables 1 and 2) has characteristics shown in Tables 1 and 2.

TABLE 1

| | | Examples | | | | | | | |
|---|---|---|---|---|---|---|---|---|---|
| Item | | 1 | 2 | 3 | 4 | 5 | 6 | 7 | 8 |
| LL | Specific Gravity | 0.892 | 0.897 | 0.900 | 0.902 | 0.902 | 0.903 | 0.904 | 0.906 |
| | DSC Melting Point | 72.0 | 73.1 | 77.7 | 79.5 | 98.0 | 81.1 | 87.0 | 82.7 |
| | TMA Softening Temperature | 88.2 | 88.3 | 89.4 | 89.5 | 96.3 | — | 94.5 | 90.6 |
| Evaluation | Surface Resistance Value | ◯ | ◯ | ◯ | ◯ | ◯ | ◯ | ◯ | ◯ |
| | Static Decay Time | ◯ | ◯ | ◯ | ◯ | ◯ | ◯ | ◯ | ∘ |
| | Light Transmissivity | ◯ | ◯ | ◯ | ◯ | ◯ | ◯ | ◯ | ◯ |
| | Haze | ◯ | ◯ | ◯ | ◯ | ◯ | ◯ | ◯ | ◯ |
| | Peeling Strength | ⊚ | ⊚ | ⊚ | ⊚ | ⊚ | ⊚ | ⊚ | ⊚ |
| | Peeling Strength Stability | ◯ | ◯ | ◯ | ◯ | ◯ | ◯ | ◯ | ◯ |
| | Zip-Up | ◯ | ◯ | ◯ | ◯ | ◯ | ◯ | ◯ | ◯ |
| | Heat Resistance | ◯ | ◯ | ◯ | ◯ | ◯ | ◯ | ◯ | ◯ |

### COMPARATIVE EXAMPLES 1 TO 4

The cover tapes in Comparative Examples 1 to 4 were formed of the same materials as those of Example 1, except that the metallocene LLDPE has characteristics shown in Table 2.

TABLE 2

| | | Examples | | Comparative Examples | | | |
|---|---|---|---|---|---|---|---|
| Item | | 9 | 10 | 1 | 2 | 3 | 4 |
| LL | Specific Gravity | 0.888 | 0.891 | 0.908 | 0.911 | 0.913 | 0.916 |
| | DSC Melting Point | 65.4 | 67.5 | 104 | 100 | 108 | 116 |
| | TMA Softening Temperature | 75.6 | 84.8 | 104.3 | 103.8 | 105.2 | 104.3 |
| Evaluation | Surface Resistance Value | ◯ | ◯ | ◯ | ◯ | ◯ | ◯ |
| | Static Decay Time | ◯ | ◯ | ◯ | ◯ | ◯ | ◯ |
| | Light Transmissivity | ◯ | ◯ | ◯ | ◯ | ◯ | ◯ |
| | Haze | ◯ | ◯ | ◯ | ◯ | ◯ | ◯ |
| | Peeling Strength | ⊚ | ⊚ | ⊚ | ⊚ | ◯ | ◯ |
| | Peeling Strength Stability | ◯ | ◯ | X | X | X | X |
| | Zip-Up | ◯ | ◯ | ◯ | X | ◯ | X |
| | Heat Resistance | Δ | Δ | ◯ | ◯ | ◯ | ◯ |

In Tables 1 and 2, a unit of density is g/cm³, and a unit of DSC melting point and TMA softening temperature is ° C.

(Evaluation)

Tables 1 and 2 show the evaluations of the cover tapes of Examples' 1 to 10 and Comparative Examples 1 to 4. The evaluations include a surface resistance, a static decay time, a total light transmissivity, a haze, a peeling strength, a peeling strength stability, a zip-up property, and a heat resistance, which were measured as follows.

The surface resistance was measured by using Hiresta-UP (manufactured by Mitsubishi Chemical Corporation, trade name) at a temperature of 22° C. and a relative humidity of 40%. An acceptable range of from 10⁵Ω/□ to 10¹³Ω/□ is represented by a mark ◯. A static decay time was measured by using STATIC-DECAY-METER-400C (manufactured by Electro-Tech-Systems, Inc., trade name), in which a time necessary for reducing a charge of 5000 V by 99% was measured in compliance with MIL-B-81705C, at a temperature of 23±5° C. and a relative humidity of 12±3%. An acceptable range equal to or less than 2 seconds is represented by a mark ◯. The total light transmissivity and the haze were measured by using a color computer SM-55C (manufactured by Suga Test Instruments, Co., Ltd., trade name). As to the total light transmissivity, an acceptable range equal to or more than 75% is represented by a mark ◯. As to the haze, an acceptable range equal to or less than 50% is represented by a mark ◯.

The peeling strength was measured for the objects which had been heat-sealed under the conditions described below, at a peeling velocity of 300 mm/minute and a peeling angle of 180°, by using PEEL-BACK-TESTER (Vanguard Systems, Inc., trade name) at a temperature of 23° C. and the relative humidity of 40%. An acceptable range of from 0.1 N/mm width to less than 0.4 N/mm width is represented by a mark ◯. A more suitable range of from 0.4 N/mm width to 0.7 N/mm width is represented by a mark ⊚.

The heat-sealing conditions were as follows. Each of the cover tapes in Examples 1 to 10 and Comparative Examples 1 to 4 was heat-sealed to a carrier tape as a conductive PS sheet of 16 mm in width, at a temperature of 140° C. and a pressure of 29.4 N/cm², for a period of 0.4 sec. A sealing head of 0.5 mm in width×2 lines and 16 mm in length was used, with a feed length of the sealing head being 8 mm. A heat-sealed part by 50 shots (8+392+8 mm) was formed, and a portion of 25 shots (200 mm) was taken as a sample.

In order to investigate the peeling strength stability, the heat-sealed samples were left for one week at a temperature of 40° C. and a relative humidity of 90%. As to a difference between the former (initial) peeling strength and the latter (one-week elapsed) peeling strength, a difference equal to or less than 0.1 N is represented by a mark ◯ meaning acceptable, while a difference equal to or more than 0.1 N is represented by a mark X meaning unacceptable.

The zip-up property is a difference between a maximum value of the peeling strength and a minimum value thereof. The zip-up equal to or less than 0.3 N is represented by a mark ◯ meaning acceptable.

In order to investigate the heat resistance, pieces of 50 mm×50 mm in size were cut out from the respective cover tapes of Examples 1 to 10 and Comparative Examples 1 to 4, and ten cut-out pieces were stacked in the same direction. The stacked pieces were pressurized at 20 N/cm², and stored for 7 days at a temperature of 60° C. Thereafter, the heat resistance for each of the pieces was evaluated. The pieces capable of being easily separated without any mold flash are represented by a mark 0 meaning acceptable. The pieces somewhat bonded to each other but showing no problem in practical use with some negligible mold flash are represented by a mark Δ also meaning acceptable. The pieces tightly bonded to each other, the pieces incapable of being separated from each other, and the pieces having a significantly large mold flash are represented by a mark X meaning unacceptable.

With reference to Table 1, as to the cover tapes of Examples 1 to 8, all the properties are evaluated as ◯. With reference to Table 2, as to the cover tapes of Examples 9 and 10, only the heat resistance is evaluated as Δ, while other properties are evaluated as ◯. As to the cover tapes of Comparative Examples 1 and 3, the peeling strength stability is unacceptable. In the cover tapes of Comparative Examples 2 and 0.4, the peeling strength stability and the zip-up property are unacceptable.

1. A cover tape for tape-packaging electronic components, for heat-sealing a carrier tape storing therein electronic components, comprising:
a substrate film layer;
a soft material layer; and
a thermal adhesive layer; wherein
the soft material layer is formed of metallocene linear low-density polyethylene; and
the metallocene linear low-density polyethylene has a specific gravity in a range of from 0.888 to 0.907.

2. The cover tape for tape-packaging electronic components according to claim 1, wherein
the metallocene linear low-density polyethylene has a specific gravity in a range of from 0.892 to 0.907.

3. A cover tape for tape-packaging electronic components, for heat-sealing a carrier tape storing therein electronic components, comprising:
a substrate film layer;
a soft material layer; and
a thermal adhesive layer; wherein
the soft material layer is formed of metallocene linear low-density polyethylene; and
a softening temperature of the metallocene liner low-density polyethylene measured by a TMA method defined in JIS K7196 is in a range of from 75° C. to 97° C.

4. The cover tape for tape-packaging electronic components according to claim 1, wherein
a softening temperature of the metallocene linear low-density polyethylene measured by a TMA method defined in JIS K7196 is in a range of from 75° C. to 97° C.

5. The cover tape for tape-packaging electronic components according to claim 1, wherein
in a case where the thermal adhesive layer heat-seals the carrier tape, the thermal adhesive layer and the soft material layer are separated from each other in the heat-sealed area upon a peeling operation of the cover tape for tape-packaging electronic components from the carrier tape;
a peeling strength upon separation of the soft material layer from the thermal adhesive layer is in a range of from 0.1 N/mm width to 1.3 N/mm width, and
a difference between a maximum value of the peeling strength upon separation of the soft material layer from the thermal adhesive layer and a minimum value thereof is equal to or less than 0.3 N/mm width.

6. The cover tape for tape-packaging electronic components according to claim 2, wherein
in a case where the thermal adhesive layer heat-seals the carrier tape, the thermal adhesive layer and the soft material layer are separated from each other in the heat-sealed area upon a peeling operation of the cover tape for tape-packaging electronic components from the carrier tape;
a peeling strength upon separation of the soft material layer from the thermal adhesive layer is in a range of from 0.1 N/mm width to 1.3 N/mm width, and
a difference between a maximum value of the peeling strength upon separation of the soft material layer from the thermal adhesive layer and a minimum value thereof is equal to or less than 0.3 N/mm width.

7. The cover tape for tape-packaging electronic components according to claim 3, wherein
in a case where the thermal adhesive layer heat-seals the carrier tape, the thermal adhesive layer and the soft material layer are separated from each other in the heat-sealed area upon a peeling operation of the cover tape for tape-packaging electronic components from the carrier tape;
a peeling strength upon separation of the soft material layer from the thermal adhesive layer is in a range of from 0.1 N/mm width to 1.3 N/mm width, and
a difference between a maximum value of the peeling strength upon separation of the soft material layer from the thermal adhesive layer and a minimum value thereof is equal to or less than 0.3 N/mm width.

8. The cover tape for tape-packaging electronic components according to claim 4, wherein
in a case where the thermal adhesive layer heat-seals the carrier tape, the thermal adhesive layer and the soft material layer are separated from each other in the heat-sealed area upon a peeling operation of the cover tape for tape-packaging electronic components from the carrier tape;
a peeling strength upon separation of the soft material layer from the thermal adhesive layer is in a range of from 0.1 N/mm width to 1.3 N/mm width, and
a difference between a maximum value of the peeling strength upon separation of the soft material layer from the thermal adhesive layer and a minimum value thereof is equal to or less than 0.3 N/mm width.
